(19) United States
(12) Patent Application Publication
(10) Pub. No.: US 2014/0122037 A1
(43) Pub. Date: May 1, 2014

(54) CONDITIONING RANDOM SAMPLES OF A SUBTERRANEAN FIELD MODEL TO A NONLINEAR FUNCTION

(71) Applicant: Schlumberger Technology Corporation, Sugar Land, TX (US)

(72) Inventors: Michael David Prange, Somerville, MA (US); William J. Bailey, Somerville, MA (US); Jean-Pierre Bourge, Kuala Lumpar (MY); Ching Mei Pang, Selangor (MY)

(73) Assignee: Schlumberger Technology Corporation, Sugar Land, TX (US)

(21) Appl. No.: 14/055,141

(22) Filed: Oct. 16, 2013

Related U.S. Application Data
(60) Provisional application No. 61/719,043, filed on Oct. 26, 2012.

(51) Int. Cl. G01V 99/00

(52) U.S. Cl. CPC G01V 99/005
USPC 703/2; 703/10

(57) ABSTRACT

A method for performing a field operation in a field includes obtaining subterranean field models that are generated based on measured data of a portion of the field. The subterranean field models include statistically derived data for a remainder portion of the field where the measured data is not available. Using a constraint optimization algorithm, weighting factors are determined that represent contributions of the subterranean field models to a combined model. The weighting factors are determined based on a statistical constraint defined by a statistical distribution of the subterranean field models and based on an optimization constraint such that a difference between a modeled value of the field and a pre-determined target value is less than a pre-determined threshold. The combined model is generated from the subterranean field model based on the weighting factors A field operation is performed based on the combined model.

### CROSS REFERENCE TO RELATED APPLICATIONS

This application claims priority under 35 U.S.C. §119(e) from Provisional Patent Application No. 61/719,043 filed Oct. 26, 2012, entitled “CONDITIONING RANDOM SAMPLES TO ANY NONLINEAR FUNCTION OF A RESERVOIR MODEL,” which is hereby incorporated by reference in its entirety.

### BACKGROUND

Operations, such as geophysical surveying, drilling, logging, well completion, and production, are performed to locate and gather valuable downhole fluids. The subterranean assets are not limited to hydrocarbons such as oil, throughout this document, the terms “oilfield” and “oilfield operation” may be used interchangeably with the terms “field” and “field operation” to refer to a site where any type of valuable fluids or minerals can be found and the activities required to extract them. The terms may also refer to sites where substances are deposited or stored by injecting the substances into the surface using boreholes and the operations associated with the injection process. Further, the term “field operation” refers to an operation associated with a field, including activities related to field planning, wellbore drilling, wellbore completion, and/or production using the wellbore.

During the field operations, data is typically collected for analysis and/or monitoring of the field operations. Such data may include, for example, subterranean formation, equipment, historical and/or other data. Data concerning the subterranean formation is collected using a variety of sources. Such formation data may be static or dynamic. Static data relates to, for example, formation structure, and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein.

Sources used to collect static data may be seismic tools, such as a seismic truck that sends compression waves into the earth. Signals from the compression waves are processed and interpreted to characterize changes in the anisotropic and/or elastic properties, such as velocity and density, of the geological formation at various depths. This information may be used to generate basic structural maps of the subterranean formation. Other static measurements may be gathered using downhole measurements, such as core sampling and well logging techniques. Core samples may be used to take physical specimens of the formation at various depths. Well logging involves deployment of a downhole tool into the wellbore to collect various downhole measurements, such as density, resistivity, etc., at various depths. Such well logging may be performed using, for example, a drilling tool and/or a wireline tool. Once the well is formed and completed, fluid flows to the surface using production tubing and other completion equipment. As fluid passes to the surface, various dynamic measurements, such as fluid flow rates, pressure, and composition may be monitored. These parameters may be used to determine various characteristics of the subterranean formation.

Sensors may be positioned about an oilfield to collect data relating to various field operations. For example, sensors in the drilling equipment may monitor drilling conditions, sensors in the wellbore may monitor fluid composition, sensors located along the flow path may monitor flow rates, and sensors at the processing facility may monitor fluids collected. Other sensors may be provided to monitor downhole, surface, equipment or other conditions. Such conditions may relate to the type of equipment at the wellsite, the operating setup, formation parameters, or other variables of the oilfield. The monitored data is often used to make decisions at various locations of the oilfield at various times. Data collected by these sensors may be further analyzed and processed. Data may be collected and used for current or future operations. When used for future operations at the same or other locations, such data may sometimes be referred to as historical data.

The data may be used to predict downhole conditions, and make decisions concerning field operations. Such decisions may involve well planning, well targeting, well completions, operating levels, production rates and other operations and/or operating parameters. Accordingly, decisions may be made as to when to drill new wells, re-complete existing wells, or alter wellbore production. Oilfield conditions, such as geological, geophysical and reservoir engineering characteristics may have an impact on field operations, such as risk analysis, economic valuation, and mechanical considerations for the production of subsurface reservoirs.

Data from one or more wellbores may be analyzed to plan or predict various outcomes at a given wellbore. In some cases, the data from neighboring wellbores or wellbores with similar conditions or equipment may be used to predict how a well will perform. Usually, a large number of variables and large quantities of data may be used to consider in analyzing field operations. It is, therefore, often useful to model the behavior of the field operation to determine the desired course of action. During the ongoing operations, the operating parameters may be adjusted as oilfield conditions change and new information is received.

### SUMMARY

In general, in one aspect, embodiments relate to performing a field operation in a field. Specifically, one or more embodiments obtain subterranean field models that are generated based on measured data of a portion of the field. The subterranean field models include statistically derived data for a remainder portion of the field where the measured data is not available. Using a constraint optimization algorithm, weighting factors are determined that represent contributions of the subterranean field models to a combined model. The weighting factors are determined based on a statistical constraint defined by a statistical distribution of the subterranean field models and based on an optimization constraint such that a difference between a modeled value of the field and a pre-determined target value is less than a pre-determined threshold. The combined model is generated from the subterranean field model based on the weighting factors. The combined model is consistent with the measured data within a predefined tolerance threshold for the portion of the field. A field operation is performed based on the combined model.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects will be apparent from the following description and the appended claims.

### BRIEF DESCRIPTION OF DRAWINGS

The appended drawings illustrate several embodiments of conditioning random samples of a subterranean field model to a nonlinear function and are not to be considered limiting of its scope, for conditioning random samples of a subterranean field model to a nonlinear function may admit to other equally effective embodiments.

FIG. 1 is a schematic view, partially in cross-section, of a field in which one or more embodiments of conditioning random samples of a subterranean field model to a nonlinear fiction may be implemented.

FIG. 2 shows an exploration and production (E&P) computer system accordance with one or more embodiments.

FIG. 3 is a flowchart depicting a method of conditioning random samples of a subterranean field model in accordance with one or more embodiments.

FIG. 4 shows an example of conditioning random samples of a subterranean field model in accordance with one or more embodiments.

FIG. 5 depicts a computer system using which one or more embodiments of conditioning random samples of a subterranean field model to a nonlinear function may be implemented.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

In general, embodiments provide a method and a system for generating a weighted combination of subterranean field models of a field. In one or more embodiments, the weighted combination (referred to as a combined model) uses weighting factors that are determined based on a statistical constraint defined by a statistical distribution of the subterranean field models. In one or more embodiments, a field operation is performed based on the combined model. Throughout this disclosure, the terms “subterranean field model,” “field model,” and “model” may be used interchangeably depending on the context.

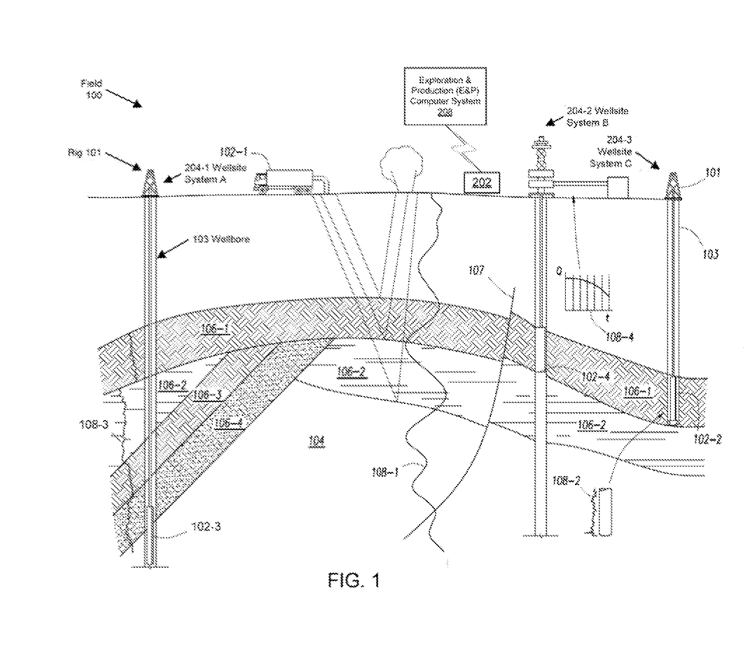

FIG. 1 depicts a schematic view, partially in cross section, of a field (100) in which one or more embodiments of conditioning random samples of a subterranean field model to a nonlinear function may be implemented. In one or more embodiments, one or more of the modules and elements shown in FIG. 1 may be omitted, repeated, and/or substituted. Accordingly, embodiments of conditioning random samples of a subterranean field model to a nonlinear function should not be considered limited to the specific arrangements of modules shown in FIG. 1.

As shown in FIG. 1, the field (100) includes the subterranean formation (104), data acquisition tools (102-1), (102-2), (102-3), and (102-4), wellsite system A (204-1), wellsite system B (204-2), wellsite system C (204-3), a surface unit (202), and an exploration and production (E&P) computer system (208). The subterranean formation (104) includes several geological structures, such as a sandstone layer (106-1), a limestone layer (106-2), a shale layer (106-3), a sand layer (106-4), and a fault line (107).

In one or more embodiments, data acquisition tools (102-1), (102-2), (102-3), and (102-4) are positioned at various locations along the field (100) for collecting data of the subterranean formation (104), referred to as survey operations. In particular, these data acquisition tools are adapted to measure the subterranean formation (104) and detect the characteristics of the geological structures of the subterranean formation (104). For example, data plots (108-1), (108-2), (108-3), and (108-4) are depicted along the field (100) to demonstrate the data generated by these data acquisition tools. Specifically, the static data plot (108-1) is a seismic two-way response time. Static plot (108-2) is core sample data measured from a core sample of the formation (104). Static data plot (108-3) is a logging trace, referred to as a well log. Production decline curve or graph (108-4) is a dynamic data plot of the fluid flow rate over time. Other data may also be collected, such as historical data, user inputs, economic information, and/or other measurement data and other parameters of interest.

Further as shown in FIG. 1, each of the wellsite system A (204-1), wellsite system B (204-2), and wellsite system C (204-3) is associated with a rig, a wellbore, and other wellsite equipment configured to perform wellbore operations, such as logging, drilling, fracturing, production, or other applicable operations. For example, the wellsite system (204) is associated with a rig (101), a wellbore (103), and drilling equipment to perform drilling operation. Similarly, the wellsite system B (204-2) and wellsite system C (204-3) are associated with respective rigs, wellbores, other wellsite equipments, such as production equipment and logging equipment to perform production operation and logging operation, respectively. Generally, survey operations and wellbore operations are referred to as field operations of the field (100). In addition, data acquisition tools and wellsite equipments are referred to as field operation equipments. These field operations are typically performed as directed by a surface unit (202). For example, the field operation equipments may be controlled by a field operation control signal sent from the surface unit (202).

In one or more embodiments, the surface unit (202) is operatively coupled to the data acquisition tools (102-1), (102-2), (102-3), (102-4), and/or the wellsite system (204). In particular, the surface unit (202) is configured to send commands to the data acquisition tools (102-1), (102-2), (102-3), (102-4), and/or the wellsite system (204) and to receive data therefrom. In one or more embodiments, surface unit (202) may be located at the wellsite system (204) and/or remote locations. The surface unit (202) may be provided with computer facilities for receiving, storing, processing, and/or analyzing data from the data acquisition tools (102-1), (102-2), (102-3), (102-4), the wellsite system (204), and/or other pan of the field (104). The surface unit (202) may also be provided with or functionally for actuating mechanisms at the field (100). The surface unit (202) may then send command signals to the field (100) in response to data received, for example to control and/or optimize various field operations described above.

In one or more embodiments, the surface unit (202) is communicatively coupled to an E&P computer system (208). In one or more embodiments, the data received by the surface unit (202) may be sent to the E&P computer system (208) for further analysis. Generally, the E&P computer system (208) is configured to analyze, model, control, optimize, or perform management tasks of the aforementioned field operations based on the data provided from the surface unit (202). In one or more embodiments, the E&P computer system (208) is provided with functionality for manipulating and analyzing the data, such as performing seismic interpretation or borehole resistivity image log interpretation to identify geological surfaces in the subterranean formation (104) or performing simulation, planning, and optimization of production operations of the wellsite system (204). In one or more embodiments, the result generated by the E&P computer system (208) may be displayed for user viewing using a two dimensional (2D) display, three dimensional (3D) display, or other suitable displays. Although the surface unit (202) is shown as separate from the E&P computer system (208) in FIG. 1, in other examples, the surface unit (202) and the E&P computer system (208) may also be combined.

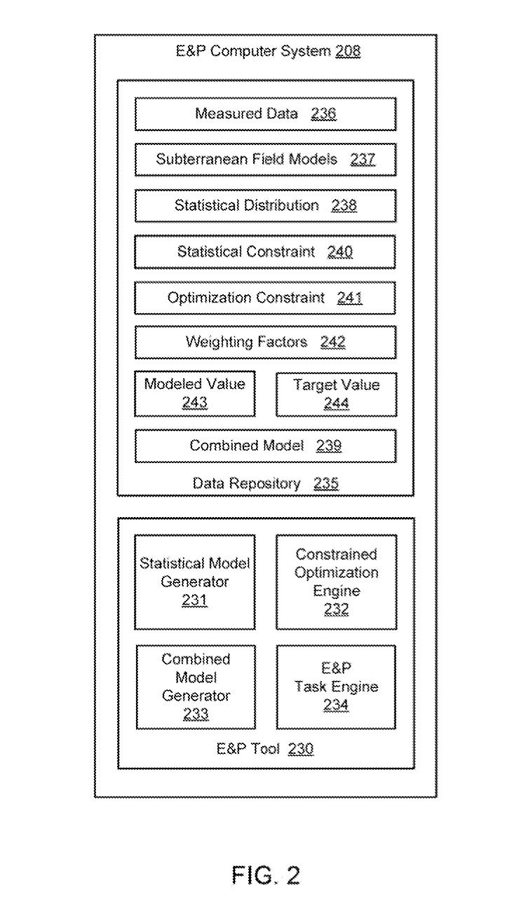

FIG. 2 shows more details of the E&P computer system (208) in which one or more embodiments of conditioning random samples of a subterranean field model to a nonlinear function may be implemented. In one or more embodiments, one or more of the modules and elements shown in FIG. 2 may be omitted, repeated, and/or substituted. Accordingly, embodiments of conditioning random samples of a subterranean field model to a nonlinear function should not be considered limited to the specific arrangements of modules shown in FIG. 2.

As shown in FIG. 2, the E&P computer system (208) includes an E&P tool (230) and a data repository (235) for storing intermediate data and resultant outputs of the E&P tool (230). In one or more embodiments, the data repository (235) may include a disk drive storage device, a semiconductor storage device, other suitable computer data storage device, or combinations thereof. In one or more embodiments, content stored in the data repository (235) may be a data file, a linked list, a data sequence, a database, a graphical representation, or any other suitable data structure.

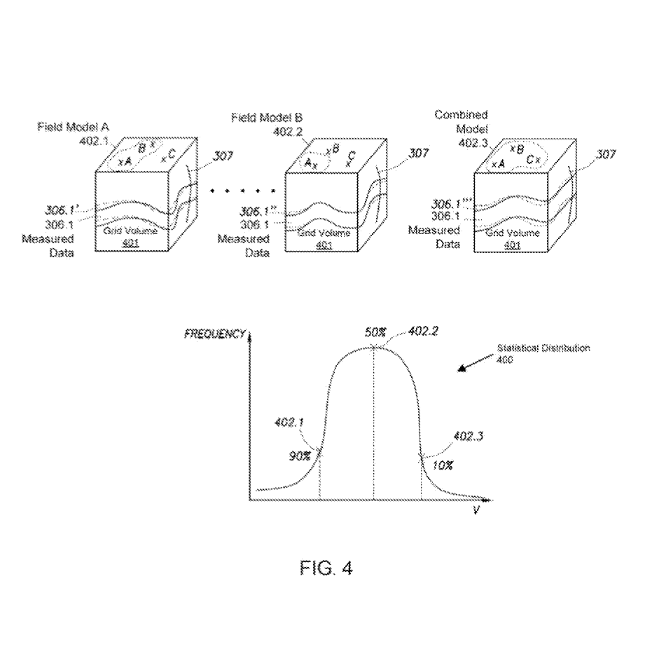

In one or more embodiments, E&P tool (230) includes a statistical model generator (231) that is configured to generate a set of subterranean field models (237) based on measured data (236). Generally, a subterranean field model is a mathematical representation of the subterranean formation (104), or a portion of the subterranean formation (104). In one or more embodiments, each of the subterranean field models (237) includes modeled data assigned to grid cells of a grid volume, where the grid volume represents the subterranean formation (104), or a portion of the subterranean formation (104). In other words, the modeled data is the value of one or more properties of a section of the subterranean formation (104) represented by a particular grid cell. For example, the modeled data may include one or more of porosity, initial saturations (oil, gas and/or water), permeability (both vertical and horizontal), net-to-gross ratio, lithology indicator(s), total organic content, natural fractures, natural barriers to flow (including clay-smeared fractures or thin—but aerially expansive—shale layers), stress magnitude and orientations, elastic properties, bulk rock density, etc. In one or more embodiments, the measured data (236) includes well log data and/or seismic data, such as the static data plots (108-1), (108-2), and/or (108-3) depicted in FIG. 1 above. While the modeled data of the subterranean field models (237) may be determined had on the measured data (236) at those grid cells corresponding to wellsites and/or geological structures where the measured data (236) is obtained, the modeled data for the rest of grid cells, where the measured data (236) is not available, is statistically derived from the measured data (236) using a statistical modeling algorithm, such as a sequential Guassian simulation (SGS). Examples of the subterranean field models (237) and modeled data thereof are described in reference to FIG. 4 below.

In one or more embodiments, E&P tool (230) includes a constrained optimization engine (232) that is configured to determine a number of weighting factors (242), which are numerical factors that represent contributions of the subterranean field models (237) to a combined model (239). Specifically, the combined model (239) is a weighted combination of the subterranean field models (237). In one or more embodiments, the weighting factors (242) are determined based on a statistical constraint (240) defined by a statistical distribution (238) of the subterranean field models (237). In particular, the term “statistical constraint” refers to a mathematical formula, in a statistical format, that is required to be satisfied when solving one or more mathematical equations. Statistical constraint may be that the sum of the models (e.g., combined model) matches the statistics in the original model. In particular, the statistical distribution (238) represents statistical characteristics, across all of the subterranean field models (237), of the modeled data of a grid volume subset one or more consecutive grid cells). In one or more embodiments, the statistical distribution (238) is a multi-normal distribution (e.g., a Gaussian distribution in one or more dimensions) and the statistical constraint (240) includes an L2 norm of the weighting factors (242). For example, the statistical constraint (240) may specify the L2 norm of the weighting factors (242) to be a constant, such as 1. In one or more embodiments, the statistical distribution (238) deviates from a Gaussian distribution and the statistical constraint (240) is in a format, different than the L2 norm, defined by the statistical distribution (238). In one or more embodiments, the statistical distribution (238) is converted into a multi-normal distribution (e.g., a Gaussian distribution or another normal distribution of one or more dimensions) such that the statistical constraint (240) is in a format including the L2 norm of the weighting factors (242). Examples of the statistical distribution (238), statistical constraint (240), and combined model (239) are described in reference to FIG. 4 below.

In one or more embodiments, the constrained optimization engine (232) is further configured to identify a nonlinear function that maps the combined model (239) into a modeled value (243) of the field (100) depicted in FIG. 1 above. The term “modeled value” is a value that is determined based on the combined model (239). In particular, the modeled value (243) represents a characteristic of the field (100). For example, the modeled value (243) may be a parameter (e.g., stock tank of oil initially in place (STOIIP)) of the field (100), or a portion of the field (100). In another example, the modeled value (243) may be a parameter (e.g., production fluid flow rate) of a field operation performed at the field (100). In one or more embodiments, the modeled value (243) is a resultant value of performing an analysis or simulations that apply the nonlinear function to the combined model (239).

Accordingly, the constrained optimization engine (232) is further configured to use a constraint optimization algorithm to determine the weighting factors (242) based on the target value (244). The term “target value” refers to a pre-determined target of the modeled value (243). In one or more embodiments, in addition to being determined based on the statistical constraint (240), the weighting factors (242) are determined further based on an optimization constraint (2401). For example, the optimization constraint (241) may specify a difference between the modeled value (243) and the target value (244) to be less than a pre-determined threshold. In the example where the modeled value (243) is the STOIIP, the target value (244) may be a user specified target amount of the STOIIP. In the example where the modeled value (243) is the production fluid flow rate, the target value (244) may be a historical production fluid flow rate, such as the fluid flow rate over time represented by the production decline curve or graph (108-4) depicted in FIG. 1 above.

In the scenario where constraint optimization algorithm fails to satisfy the one or more optimization constraints based on the subterranean field models (237), a Monte-Carlo accept/reject method is used based on additional and/or alternative subterranean field models. In particular, the Monte-Carlo accept/reject method is a computational algorithm using repeated random sampling to obtain numerical results.

In one or more embodiments, the nonlinear function includes a multi-normal likelihood function, where the target value includes a historical value of the field operation and an uncertainty distribution of the historical value. In such embodiments, the constraint optimization algorithm further determines a model uncertainty of the combined model (239) based on the multi-normal likelihood function and the uncertainty distribution.

Examples of the nonlinear function mapping the combined model (239) into the modeled value (243), the optimization constraint (241) of the constraint optimization algorithm, the Monte-Carlo accept/reject method, and history matching with or without uncertainty are described in reference to FIG. 4 below.

In one or more embodiments, E&P tool (230) includes a combined model generator (233) that is configured to generate the combined model (239) by combining the subterranean field models (237) based on the weighting factors (242). In one or more embodiments, the combined model (242) is consistent with the measured data (236) within a predefined tolerance threshold for the portion of the field (100) where the measured data (236) is obtained. An example of generating the combined model (239) to be consistent with the measured data (236) is described in reference to FIG. 4 below.

In one or more embodiments, E&P tool (230) includes an E& P task engine (234) that is configured to generate a field operation control signal based on the combined model (239). As noted above, the field operation equipment depicted in FIG. 1 above may be controlled by the field operation control signal. For example, the field operation control signal may be used to control an actuator, a fluid valve, or other electrical and/or mechanical devices disposed about the field (100) depicted in FIG. 1 above.

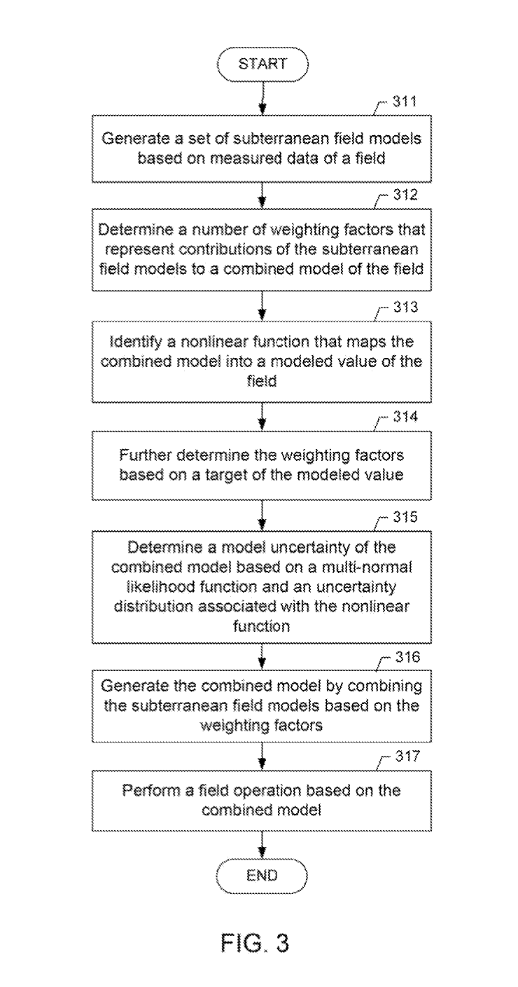

FIG. 3 depicts an example method of conditioning random samples of a subterranean field model to a nonlinear function in accordance with one or more embodiments. For example, the method depicted in FIG. 3 may be practiced using the E&P computer system (208) described in reference to FIGS. 1 and 2 above. In one or more embodiments, one or more of the elements shown in FIG. 3 may be omitted, repeated, and/or performed in a different order. Accordingly, embodiments of the conditioning random samples of a subterranean field model to a nonlinear function should not be considered limited to the specific arrangements of elements shown in FIG. 3.

Initially in Element 311, a set of subterranean field models are generated based on measured data of a field. In one or more embodiments, well log data and/or seismic data are obtained from the field as the measured data. In one or embodiments, modeled data are derived from the measured data and assigned to grid cells of a grid volume to form a subterranean field model. The modeled data assigned to certain grid cells may be determined directly from the measured data. For example, the modeled data may be determined directly from the measured data for the grid cells corresponding to wellsites and/or geological structures where the measured data is obtained. The modeled data for the rest of grid cells, where the measured data is not available, may be statistically derived from the measured data using a statistical modeling algorithm, such as a sequential Guassian simulation (SGS). Various modeling techniques may be used to determine modeled data from the measured data. When different techniques and/or parameters are applied, different subterranean field models may result. In one or more embodiments, the subterranean field models are generated using the statistical model generator depicted in FIG. 2 above. Examples of the subterranean field models and modeled data thereof are described in reference to FIG. 4 below.

In Element 312, a number of weighting factors are determined to represent contributions of the subterranean field models to a combined model of the field. Specifically, the combined model is a weighted combination of the subterranean field models. In one or more embodiments, the weighting factors are determined using the constrained optimization engine depicted in FIG. 2 above. As noted above, the constrained optimization engine generates the weighting factors such that the weighting factors satisfy a statistical constraint that is defined by a statistical distribution of the subterranean field models. For example, when the statistical distribution is a multi-normal distribution (e.g., a Gaussian distribution or another normal distribution of one or more dimensions), the statistical constraint is an L2 norm of the weighting factors. In one or more embodiments, the constrained optimization engine generates the weighting factors such that the L2 norm of the weighting factors equals a constant, such as 1. Examples of the weighting factors and the combined model are described in reference to FIG. 4 below.

In Element 313, a function is identified to map the combined model into a modeled value of the field. In one or more embodiments, an analysis or simulation is performed by applying the function to the combined model to generate the modeled value. For example, the modeled value may be a parameter (e.g., stock tank of oil initially in place (STOIIP)) of the field, or a portion of the field. In another example, the modeled value may be a parameter (e.g., production fluid flow rate) of a field operation performed at the field. In one or more embodiments, the function is a nonlinear function.

In Element 314, using a constraint optimization algorithm, the weighting factors are determined based on a pre-determined target of the modeled value, referred to as the pre-determined target value. In one or more embodiments, in addition to being determined based on the aforementioned statistical constraint, the weighting factors are determined further based on an optimization constraint. For example, the optimization constraint may specify a difference between the modeled value and the target value to be less than a pre-determined threshold. In other words, the modeled value is calculated using, the aforementioned nonlinear function and matched to the target value for satisfying the optimization constraint. In the example where the modeled value is the STOIIP, the target value may be a user specified target amount of the STOIIP. In the example where the modeled value is the production fluid flow rate, the target value may be a historical production fluid flow rate over time. In one or more embodiments, the constraint optimization algorithm is configured to determine the weighting factors while satisfying both the optimization constraint and the aforementioned statistical constraint simultaneously.

In the scenario where constraint optimization algorithm fails to satisfy the optimization constraints based on the subterranean field models, a Monte-Carlo accept/reject method is used based on additional and/or alternative subterranean field models. In one or more embodiments, the aforementioned SOS is used to generate additional and/or alternative subterranean field models such that Elements 312 through 314 are repeated.

In Element 315, a model uncertainty of the combined model is determined based on a multi-normal likelihood function and an uncertainty distribution associated with the nonlinear function. In particular, the nonlinear function includes a multi-normal likelihood function, where the target value includes a historical value of the field operation and an uncertainty distribution of the historical value. In such embodiments, the constraint optimization algorithm further determines a model uncertainty of the combined model based on the multi-normal likelihood function and the uncertainty distribution.

Examples of the nonlinear function mapping the combined model into the modeled value, the optimization constraint of the constraint optimization algorithm, the Monte-Carlo accept/reject method, and history matching with or without uncertainty are described in reference to FIG. 4 below.

In Element 316, the combined model is generated by combining the subterranean field models based on the weighting factors. In one or more embodiments, the combined model is consistent with the measured data within a predefined tolerance threshold for the portion of the field where the measured data is obtained. In one or more embodiments, the combined model is generated using the combined model generator depicted in FIG. 2 above. An example of generating the combined model to be consistent with the measured data is described in reference to FIG. 4 below.

In Element 317, a field operation is performed based on the combined model. For example, performing the field operation may include generating a field operation control signal based on the combined model. In one or more embodiments, field operation equipments are controlled by the field operation control signal. For example, the field operation control signal may be used to control an actuator, a fluid valve, or other electrical and/or mechanical devices disposed about the field. In one or more embodiments, the field operation control signal is generated using the E&P task engine depicted in FIG. 2 above.

FIG. 4 shows examples of subterranean field models and a combined model in accordance with one or more embodiments. These examples may be based on the system (100) of FIG. 1 and the method described with respect to FIG. 2 above. Although FIG. 4 shows implementation examples of embodiments of the invention, those skilled in the art will appreciate that there may be other ways in which to implement embodiments of the invention, and that the example descriptions are not meant to limit the scope of the invention.

Specifically, FIG. 4 shows a number of field models (i.e., field model A (402.1), field model B (402.2)), a combined model (402.3), and a statistical distribution (400). In particular, the field model A (402.1), field model B (402.2), etc. are examples of subterranean field models (237) shown in FIG. 2 above. Specifically, the field model A (402.1), field model B (402.2), etc. are generated using sequential Gaussian simulation method described above. In addition, the combined model (402.3) and the statistical distribution (400) are examples of the combined model (239) and the statistical distribution (238), respectively, shown in FIG. 2 above. Specifically, the statistical distribution (400) represents statistical characteristics of the field model A (402.1), field model B (402.2), etc.

As shown in FIG. 4, each of the field models (i.e., field model A (402.1), field model B (402.2), etc.) and the combined model (402.3) is schematically shown as modeled data assigned to a grid volume (401) where the grid volume (401) represents a portion of the field (100) shown in FIG. 1 above. Further, the measured data (306.1) superimposing the grid volume (401) is an example of the measured data (236) shown in FIG. 2 above, and is used by the sequential Gaussian simulation to generate the field model A (402.1), field model B (402.2), etc. . . . In particular, the measured data (306.1) may include seismic data, core sample data, and well log data corresponding to data plot (108-1), data plot (108-2), and data plot (108-3), respectively, shown in FIG. 1 above. The portion of the field (100) where the data plot (108-1), data plot (108-2), and data plot (108-3) are obtained corresponds to a subset (307) of the grid volume (401). Specifically as shown in FIG. 4, the subset (307) includes a curve penetrating a curved layer. In particular, the curve corresponds to the wellbore (103) shown in FIG. 1 above, and the curved layer corresponds to a geological structure, such as the sandstone layer (106-1), limestone layer (106-2), shale layer (106-3), or sand layer (106-4) shown in FIG. 1 above. Further, a remainder portion of the grid volume outside of the subset (307) includes points A, B, C, etc. where no measured data is available at corresponding locations of the field (100). As noted above, modeled data assigned to these points A, B, C, etc. are derived using sequential Gaussian simulation based on the measured data corresponding to the subset (307).

Further as shown in FIG. 4, the statistical distribution (400) is a Guassian distribution of the modeled data across all field models (i.e., field model A (402.1), field model B (402.2), etc.). For example, the horizontal axis of the statistical distribution (400) may represent values (v) of modeled data assigned to a particular grid cell (e.g., point A, B, or C, or any point in the subset (307)) in the grid volume (401), while the vertical axis of the statistical distribution (400) may represent the frequency of occurrences (frequency) of any particular value of v occurring in all field models (i.e., field model A (402.1), field model B (402.2), etc.). In particular, the point (402.2) in the statistical distribution (400) corresponds to a mean of the Gaussian distribution, while the points (402.1) and (402.3) correspond to a variance of the Gaussian distribution. Although the statistical distribution (400) is shown in FIG. 4 as a single statistical distribution curve of modeled data assigned to a single grid cell, the grid volume (401) typically includes a large number of grid cells each having a similar statistical distribution curve representing statistical characteristics of modeled data assigned thereto.

As generated by the sequential Gaussian simulation, the statistically derived modeled data assigned to any of points A, B, C, etc., or any grid cell in the subset (307) conform to the statistical distribution (400) across the field model A (402.1), field model B (402.2). Accordingly, the modeled data assigned to a grid cell in the subset (307) statistically deviates from the measured data (306.1). Such deviation is schematically represented in FIG. 4 as the gap (306.1′), gap (306.1″). By way of the sequential Gaussian simulation, the field model A (402.1), field model B (402.2), are consistent with the measured data (306.1) within a pre-determined threshold. In other words, the differences represented as the gap (306.1′), gap (306.1″), are less than the pre-determined threshold. Similar to the gap (306.1′), gap (306.1″), the difference between the measured data (306.1) and the modeled data assigned to the subset (307) in the combined model (402.3) is schematically represented as the gap (306.1′″). In one or more embodiments, based on the system (100) of FIG. 1 and the method described with respect to FIG. 3 above, the combined model (402.3) is also consistent with the measured data (306.1) within the pre-determined threshold. In other words, the difference represented as the gap (306.1′″) is less than the pre-determined threshold. The method to generate the combined model (402.3) from the field model A (402.1), field model B (402.2), are described in the example below where the field model A (402.1), field model B (402.2), and the combined model (402.3) are reservoir models.

The properties (i.e., modeled data) of reservoir models (i.e., field model A (402.1), field model B (402.2), etc.) may be populated using sequential Gaussian simulation (SGS) conditioned on well and/or seismic data (i.e., measured data (306.1)). Each model generated by SGS is a multi-normal random sample that is consistent with the conditioning data (i.e., measured data (306.1)). The combined model (402.3) is generated by further conditioning these SGS generated reservoir models on other information (i.e., optimization constraint (241) shown in FIG. 2) that may be nonlinearly related to the reservoir model. For example, these SGS generated reservoir models may be further conditioned on a user specified value of STOIIP (Stock Tank of Oil Initially In Place) for a reservoir or further conditioned on historical production data in solving a history-matching problem. The history-matching problem refers to the conditioning of a reservoir simulation model such that predictions (e.g., related to fluid production, fluid pressures, time-to-arrival, aquifer water, etc.) based on the reservoir simulation model match historically measured values within an acceptable range. The reservoir simulation model may then be considered representative of the actual reservoir, for performing production forecasts for new and/or existing wells regarding capital expenditures, valuation, other financial outcomes, etc. Using the example method described below, the consistency of the SGS generated models (i.e., field model A (402.1), field model B (402.2), etc.) with the conditioning data (i.e., measured data (306.1)) is preserved in the combined model (402.3).

Consider a set of random samples front the aforementioned multi-normal distribution where the number of random samples is denoted by N and the i-th model sample is denoted by mᵢ (i.e., field model A(402.1), field model B (402.2), etc.). In particular, each vector element in the vector mᵢ is modeled data assigned to a particular grid cell in the grid volume (401). In other words, the dimensionality of the vector mᵢ is the same as the number of grid cell property values in the grid volume (401). In addition, the random samples have a mean vector μ and covariance matrix C such that

mᵢ˜ [symbol] (μ, C), (1)

where the well and seismic conditioning information is implicit μ and C.

Let m denote the combined model (402.3), which is given by

m−μ=(M−μ1^{T})α, (2)

where M is a matrix with mᵢ as the i-th column of M, the operation (M−μ1^{T}) subtracts the mean from each column of M, the superscript ^{T} denotes the transpose operator, and α is an N-dimensional vector or α ∈ [symbol] ^{N}. The combined model may also be referred to as a conditioned sample. Specifically, each vector element of α is one of N weighting factors representing contribution of a particular SGS generated reservoir model into the combined model (402.3). For example, ∥α∥=1 is used as the statistical constraint (240) shown in FIG. 2 above. The notation ∥·∥ denotes the L2 norm. By generating m with the statistical constraint ∥α∥=1, m is a sample from [symbol] (μ, C), as represented by

m(α)˜ [symbol] (μ, C). (3)

In such instances, the conditioning of m to the optimization constraint (241) (e.g., the STOIIP or historical production data) shown in FIG. 2 above may be expressed as an optimization problem involving the vector elements of α. The conditioned sample m (i.e., the combined model (402.3)), as described, by α through Eq. (2), then constitutes a random sample of the reservoir model that also satisfies the additional stated conditioning (e.g., the STOIIP or historical production data). By solving the optimization problem repeatedly, additional independent random samples may be generated. In other words, additional combined models may be generated similar to the combined model (402.3).

The mathematics used in the optimization problem conditioned on the statistical constraint ∥α∥=1 and the additional optimization constraint is described below.

Consider a set of zero-mean multi-normal random variables, {ξᵢ}ᵢ₌₁^{N}, each with covariance matrix C. The probability density function for all of these zero-mean multi-normal random variables {ξᵢ}ᵢ₌₁^{N} is denoted by π(ξᵢ). While the aforementioned model sample mᵢ is a random sample from a distribution, {ξᵢ}ᵢ₌₁^{N} represents continuous random variables. The distinction allows exact expressions to be derived in Eq. (4) and Eq. (5) for the mean and covariance of a weighted sum of random variables. By the law of large numbers, the exact expressions may then be used to derive an approximate expression for the covariance of weighted sum of the model samples mᵢ's. A linear combination of these variables

$$ξ = {\sum }_{i = 1}^{N} {α}_{i} {ξ}_{i} ,$$

has the mean

$$\begin{matrix}E ( ξ ) = {\int }_{{Ω}_{1}} ξπ ( ξ ) d ξ \\ = {\int }_{Ω} ( {\sum }_{i = 1}^{N} {α}_{i} {ξ}_{i} ) ( {\prod }_{i = 1}^{N} π ( {ξ}_{i} ) d {ξ}_{i} ) \\ = {\sum }_{i = 1}^{N} {α}_{i} {\int }_{{Ω}_{i}} {ξ}_{i} π ( {ξ}_{i} ) d {ξ}_{i} \\ = 0.\end{matrix} \qquad ( 4 )$$

The covariance is therefore defined as

$$\begin{matrix}E ( {ξξ}^{T} ) = {\int }_{{Ω}_{1}} {ξξ}^{T} π ( ξ ) d ξ \\ = {\int }_{Ω} ( {\sum }_{i = 1}^{N} {α}_{i} {ξ}_{i} ) ( {\sum }_{i = 1}^{N} {α}_{i} {ξ}_{i}^{T} ) ( {\prod }_{i = 1}^{N} π ( {ξ}_{i} ) d {ξ}_{i} ) , \\ = {\sum }_{i = 1}^{N} {α}_{i}^{2} {\int }_{{Ω}_{i}} {ξ}_{i} {ξ}_{i}^{T} π ( {ξ}_{i} ) d {ξ}_{i} , \\ = C {\sum }_{i = 1}^{N} {α}_{i}^{2} ,\end{matrix} \qquad ( 5 )$$

where M denotes the dimension of ξ, Ωᵢ is the integration domain [symbol] ^{M}, and Ω is, therefore, the integration domain [symbol] ^{M} [symbol] ^{N}. More specifically, Ωᵢ is the domain of integration for random vector ξᵢ, which for a multi-normal distribution of dimension M is an M-dimensional domain extending from minus infinity to infinity. Ω is the integration domain for N such variables, namely the outer product of Ω₁ through 106 _{N}. As such,

(m−μ)=MHα˜ [symbol] (0, ∥α∥²C), (6)

where μ is subtracted from m in order to make the result zero mean. The centering matrix H is defined by

$$H = 1 - \frac{1}{N} {11}^{T} ,$$

where I is the identity matrix (i.e., the diagonal matrix, of ones) and 1 is the vector of ones. In equation (6), H acts on M to subtract the sample estimate of μ from the columns of μ. Thus,

m=μ+MHα˜ [symbol] (μ, C), (7)

when

∥α∥²=1. (8)

The foregoing demonstrates that m is drawn from the same distribution estimated from M when Eq. (8) is satisfied.

To further condition m to an optimization constraint (e.g., the STOIIP or historical production data) represented by a constraint vector d, let f(m) denote a vector function that maps a reservoir model into a vector of values specifying the optimization constraint. Thus, a random sample of m, that satisfies the optimization constraint, is given by m(α*), where

∥d−f[m(α*)]∥<ε, (9)

subject to Eq. (8) being satisfied. Parameter ε in Eq. (9) is the degree of acceptable tolerance. The solution to Eq. (9) can be expressed in terms of the following constrained optimization problem:

$${α}^{*} = arg {min}_{α} ‖ d - f [ m ( α ) ] ‖ \qquad ( 10 )$$

subject to Eq. (9) being satisfied.

If, however, Eq. (9) cannot be satisfied, samples in M may be augmented (or replaced) by additional samples from Eq. (1) in order to find another solution. Finding another solution using additional samples is a form of the Monte Carlo ‘accept/reject’ method in which random samples are drawn until the constraint is met. Although the Monte Carlo ‘accept/reject’ method is traditionally inefficient—to the point of being impractical—in this case each ‘sample’ of M is coupled with the optimization problem defined in Eq. (10) in order to elevate the likelihood of finding an m that satisfies the required constraint. If no solution can be found after a pre-determined number of iterations, the optimization constraint (e.g., the STOIIP or historical production data) represented by the constraint vector d, may then be determined as inconsistent with the prior uncertainty model [symbol] μ, C). The symbol [symbol] represents a multi-normal distribution, and the two arguments denote the mean and covariance of that distribution. As a result, either the prior uncertainty model or the optimization constraint may be revised before proceeding to any further iteration in solving the constrained optimization problem.

The constrained optimization problem may have multiple solutions. Additional independent random samples of m, conditioned on d, may be found by replacing the columns of M with a new set of samples from Eq. (1), and then solving the constrained optimization problem once again.

If d is uncertain, with distribution π(d), samples {d₁, . . . , d_{K}} may be drawn from π(d) and then used to condition K samples of m using the aforementioned algorithm. The result is a collection of K samples drawn from π(m, d)=π(m|d)π(d). The collection K samples may then be used, for example, in computing the expectation over a function of the models, e.g., in forecast optimization, by marginalizing over d, yielding the expected value of the vector function v(m), yielding

$$E ( v ) = \frac{1}{K} {\sum }_{k = 1}^{K} v ( {m}_{k} ) , \qquad ( 11 )$$

where v(m) is a functional over the space of models. In mathematics, a functional is a function that maps from a vector space into an underlying scalar field. For example, v(m) may map from a model, through a flow simulation, into a scalar representing the total production from a reservoir.

The constrained optimization problem stated in Eq. (10) (subject to Eq. (8) and. Eq. (9)) can be expressed as an unconstrained optimization problem in a bounded domain by expressing α in a hyperspherical coordinate system of unit radius. The hyperspherical coordinate system is defined by

$${α}_{1} = cos {φ}_{1} \\ {α}_{2} = sin {φ}_{1} cos {φ}_{2} \\ {α}_{2} = sin {φ}_{1} sin {φ}_{2} cos {φ}_{3} \\ ⋮ \\ {α}_{N - 1} = sin {φ}_{1} … sin {φ}_{N - 2} cos {φ}_{N - 1} \\ {α}_{N} = sin {φ}_{1} … sin {φ}_{N - 2} sin {φ}_{N - 1} , \qquad ( 12 )$$

where the bounds on φᵢ are {φ₁, φ₂, . . . , φ_{N-2}} ∈ [0, π) and φ_{N-1} ∈ [0, 2π). Using the hyperspherical coordinate system, not only is the number of optimization variables from (i.e., from N to N−1) reduced by by one, but the problem is also transformed to a simpler one that should be generally more efficient to solve and is accessible to a broader range of robust (commercial-grade) optimizers.

The optimization described above uses the constraint in Eq. (8) to reduce the dimension of the optimization space from N to N−1 by a change of variables to hyperspherical coordinates. A further reduction is possible by applying the singular value decomposition and eliminating the smallest singular values.

Consider the singular value decomposition (SVD), MH=UΛV^{T}, were U^{T}U=I, V^{T}V=I and [symbol] is a diagonal matrix sorted in order of Λ₁₁≧Λ₂₂≧ . . . ≧Λ_{NN}. Eliminating the rows and columns corresponding to the smallest diagonal elements in Λ, and eliminating the corresponding rows and columns from U and V, a truncated SVD approximation is obtained, given by

MH≈Uⱼ [symbol] ⱼVⱼ^{T}. (16)

The j subscript indicates that the diagonal of Λ has been truncated to largest j singular values. The quality of the truncated SVD approximation is indicated by

$${Q}_{j} = \frac{{\sum }_{i = 1}^{j} {Λ}_{ii}^{2}}{{\sum }_{i = 1}^{N} {Λ}_{ii}^{2}} , \qquad ( 17 )$$

where Qⱼ ∈ (0, 1]. Values close to unity therefore indicate a good approximation. The quality metric of Eq. (17) is identical to that used in choosing the appropriate level of approximation to use in principal component analysis, and corresponds to the fraction of variance retained in the prior uncertainty. In such instance, Eq. (5) may be expressed as

m≈μ+Uⱼ [symbol] ⱼβ, (18)

where α=Vⱼβ. Note that while α has N elements, β has only j elements, where j≦N.

M typically possesses many more rows than columns. Thus, it is more efficient to evaluate Eq. (18) using the eigen-decomposition of B=(MH)^{T}MH, rather than by evaluating the SVD of MH. Evaluating Eq. (18) using the eigen-decomposition is achieved by recognizing that B=VΛ²V^{T}, and thus the columns of V are the eigenvectors of B. Since the dimensions of B are typically much smaller than those of M, these eigenvectors may be obtained more efficiently than performing an SVD on MH. Using the orthonormality of V, Eq. (18) may be expressed as

m≈μ+MHVⱼβ, (19)

The change of variables in Eq. (18) is deemed favorable for reducing the size of the optimization problem since it is usually the case that j<<N. The optimization constraint on β is the same as that for α, namely

α^{T}α=β^{T}Vⱼ^{T}Vⱼβ=β^{T}β=1. (20)

As such, it remains appropriate to use hyperspherical coordinates to reduce the optimization dimension to just j−1 variables.

In summary, an approach is described in the example above for conditioning multi-normal random samples of reservoir models to constraints that are nonlinear functions of the reservoir model. Each conditioned model is an independent random sample drawn from the prior distribution associated with the SGS generated models, subject to the required conditioning constraint in accordance with one or more embodiments. The conditioning problem is reduced to a Monte Carlo ‘accept/reject’ method in which a candidate model is expressed as a linear combination of samples from the prior models, and whose linear coefficients are optimization control variables that are used to satisfy the constraint. The approach produces samples that satisfy exactly a conditioning constraint (such as an exact value of STOIIP). In order to reduce the size of the optimization problem, dimension reduction through the application of a singular value decomposition may be used. In other words, a collection of reservoir models are stochastically generated (e.g., using the SGS) such that they are compatible with well, seismic, geological and petrophysical measurements, etc. The example approach described above provides a mechanism for generating a new set of models that satisfies an additional constraint while continuing to honor the original measurements and conditions stated above. As an example, the additional constraint may require the STOIIP to be a given value or range of values. In other examples, the additional constraint may require a reservoir pore volume, fracture volume, production rate at a particular time, pressure at a specified time and matching a pre-specified production plateau period, the time when water breakthrough occurs, the time when the field reaches a pre-defined low economic viability threshold, OIIP (tank of oil initially in place at reservoir conditions, instead of stock tank or atmospheric conditions), etc. to be a given value or range of values.

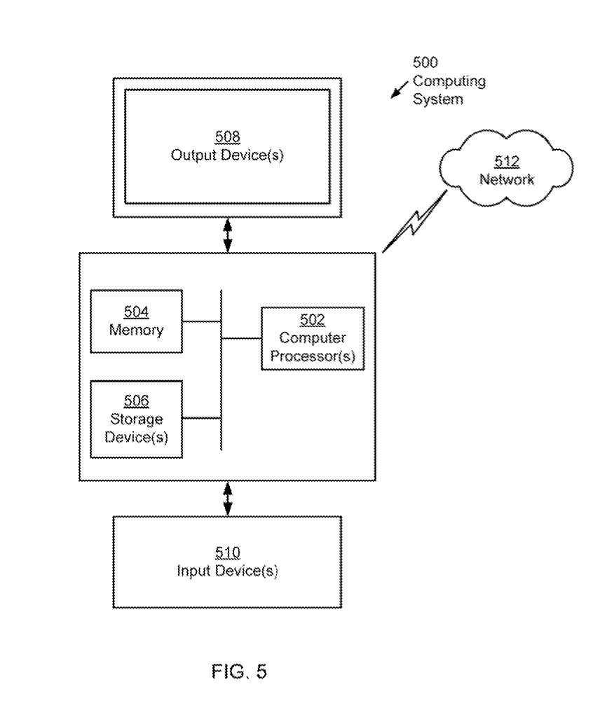

Embodiments of conditioning random samples of a subterranean field model to a nonlinear function may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of conditioning random samples of a subterranean field model to a nonlinear function. For example, as shown in FIG. 5, the computing system (500) may include one or more computer processor(s) (502), associated memory (504) (e.g., random access memory (RAM), cache memory, flash memory, etc.), one or more storage device(s) (506) (e.g., a hard disk, an optical drive such as to compact disk (CD) drive or digital versatile disk (DVD) drive, a flash memory stick, etc.), and numerous other elements and functionalities. The computer processor(s) (502) may be an integrated circuit for processing instructions. For example, the computer processor(s) may be one or more cores, or micro-cores of a processor. The computing system (500) may also include one or more input device(s) (510), such as a touchscreen, keyboard, mouse, microphone, touchpad, electronic pen, or any other type of input device. Further, the computing system (500) may include one or more output device(s) (508), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (500) may be connected to a network (512) (e.g., a local area network (LAN), a wide area network (WAN) such as the Internet, mobile network, or any other type of network) via a network interface connection (not shown). The input and output device(s) may be locally or remotely (e.g., via the network (512)) connected to the computer processor(s) (502), memory (504), and storage device(s) (506). Many different types of computing systems exist, and the aforementioned input and output device(s) may take other forms.

Software instructions in the form of computer readable program code to perform embodiments of conditioning random samples of a subterranean field model to a nonlinear function may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of conditioning random samples of a subterranean field model to a nonlinear function.

Further, one or more elements of the aforementioned computing system (500) may be located at a remote location and connected to the other elements over a network (512). Further, embodiments of conditioning random samples of a subterranean field model to a nonlinear function may be implemented on a distributed system having a plurality of nodes, where each portion of conditioning random samples of a subterranean field model to a nonlinear function may be located on a different node within the distributed system. In one embodiment of conditioning random samples of a subterranean field model to a nonlinear function, the node corresponds to a distinct computing device. Alternatively, the node may correspond to a computer processor with associated physical memory. The node may alternatively correspond to a computer processor or micro-core of a computer processor with shared memory and/or resources.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While conditioning random samples of a subterranean field model to a nonlinear function has been described with respect to a limited number of embodiments, those skilled in the art, having benefit of this disclosure, will appreciate that other embodiments can be devised which do not depart from the scope of conditioning random samples of a subterranean field model to a nonlinear function as disclosed herein. Accordingly, the scope of conditioning random samples of a subterranean field model to a nonlinear function should be limited only by the attached claims.

What is claimed is:

1. A method to perform a field operation in a field, comprising:
obtaining a plurality of subterranean field models that are generated based on measured data of a portion of the field, wherein the plurality of subterranean field models comprise statistically derived data for a remainder portion of the field where the measured data is not available;
determining, by a computer processor and using a constraint optimization algorithm, a plurality of weighting factors that represent contributions of the plurality of subterranean field models to a combined model,
wherein the plurality of weighting factors are determined based on a statistical constraint defined by a statistical distribution of the plurality of subterranean field models and based on an optimization constraint such that a difference between a modeled value of the field and a pre-determined target value is less than a pre-determined threshold, and
wherein the modeled value of the field is derived from the combined model using a pre-determined function;
generating, by the computer processor, the combined model from the plurality of subterranean field model based on the plurality of weighting factors, wherein the combined model is consistent with the measured data within a predefined tolerance threshold for the portion of the field; and
performing the field operation based on the combined model.

2. The method of claim 1, wherein the statistically derived data is derived from the measured data using a sequential Gaussian simulation.

3. The method of claim 1,
wherein the statistical distribution of the plurality of subterranean field models comprises a multi-normal distribution, and
wherein the statistical constraint requires an L2 norm of the plurality of weighting factors to be a pre-determined value.
The method of claim 1, wherein the function comprises a nonlinear function that maps the combined model into the modeled value of the field.

4. The method of claim 4, wherein the modeled value comprises a stock tank of oil initially in place.

5. The method of claim 4, wherein the modeled value comprises at least one selected from a group consisting of tank of oil initially in place, a reservoir pore volume, a fracture volume, a production rate at a particular time, a pressure at a specified time and matching a pre-specified production plateau period, a time when water breakthrough occurs, and a time when the field reaches a pre-defined low economic viability threshold.

6. The method of claim 4, wherein the constraint optimization algorithm comprises a Monte-Carlo accept/reject method.

7. A system to perform a field operation in a field, comprising:
a plurality of data acquisition tools disposed in the field and configured to generate measured data of a portion of the field;
a field operation equipment disposed in the field and configured to perform the field operation in response to a field operation control signal;
an exploration and production (E&P) tool executing on a computer processor and configured to perform E&P activities in the field, the E&P tool comprising:
a statistical model generator configured to:
generate a plurality of subterranean field models based on measured data of a portion of the field, wherein the plurality of subterranean field models comprise statistically derived data for a remainder portion of the field where the measured data is not available,
a constrained optimization engine configured to:
determine, using a constraint optimization algorithm, a plurality of weighting factors that represent contributions of the plurality of subterranean field models to a combined model,
wherein the plurality of weighting factors are determined based on a statistical constraint defined by a statistical distribution of the plurality of subterranean field models and based on an optimization constraint such that a difference between a modeled value of the field and a pre-determined target value is less than a pre-determined threshold, and
wherein the modeled value of the field is derived from the combined model using a pre-determined function,
a combined model generator configured to:
generate the combined model from the plurality of subterranean field model based on the plurality of weighting factors, wherein the combined model is consistent with the measured data within a predefined tolerance threshold for the portion of the field, and
an E&P task engine configured to generate the field operation control signal based on the combined model, and
a data repository coupled to the computer processor and configured to store the plurality of subterranean field models and the combined model.

8. The system of claim 8,
wherein the statistically derived data is derived from the measured data using a sequential Gaussian simulation, and
wherein the measured data comprises at least one selected from a group consisting of well log data and seismic data.

9. The system of claim 8,
wherein the statistical distribution of the plurality of subterranean field, models comprises a multi-normal distribution, and
wherein the statistical constraint requires an L2 norm of the plurality of weighting factors to be a pre-determined value.

10. The system of claim 8, wherein the function comprises a nonlinear function that maps the combined model into the modeled value of the field.

11. The system of claim 11, wherein the modeled value comprises a stock tank of oil initially in place.

12. The system of claim 11, wherein the modeled value comprises at least one selected from a group consisting of tank of oil initially in place, a reservoir pore volume, a fracture volume, a production rate at a particular time, a pressure at a specified time and matching a pre-specified production plateau period, a time when water breakthrough occurs, and a time when the field reaches a pre-defined low economic viability threshold.

13. The system of claim 11, wherein the constraint optimization algorithm comprises a Monte-Carlo accept/reject method.

14. A non-transitory computer readable medium comprising instructions to perform a field operation in a field, the instructions when executed by a computer processor comprising functionality for:
obtaining a plurality of subterranean field models that are generated based on measured data of a portion of the field, wherein the plurality of subterranean field models comprise statistically derived data for a remainder portion of the field where the measured data is not available;
determining, using a constraint optimization algorithm, a plurality of weighting factors that represent contributions of the plurality of subterranean field models to a combined model,
wherein the plurality of weighting factors are determined based on a statistical constraint defined by a statistical distribution of the plurality of subterranean field models and based on an optimization constraint such that a difference between a modeled value of the field and a pre-determined target value is less than a pre-determined threshold, and
wherein the modeled value of the field is derived from the combined model using a pre-determined function;
generating the combined model from the plurality of subterranean field model based on the plurality of weighting factors, wherein the combined model is consistent with the measured data within a predefined tolerance threshold for the portion of the field; and
performing the field operation based on the combined model.

15. The non-transitory computer readable medium of claim 15,
wherein the statistically derived data is derived from the measured data using a sequential Gaussian simulation, and
wherein the measured data comprises at least one selected from a group consisting of well log data and seismic data.

16. The non-transitory computer readable medium of claim 15,
wherein the statistical distribution of the plurality of subterranean field models comprises a multi-normal distribution, and
wherein the statistical constraint requires an L2 norm of the plurality of weighting factors to be a pre-determined value.

17. The non-transitory computer readable medium of claim 15, wherein the function comprises a nonlinear function that maps the combined model into the modeled value of the field.

18. The non-transitory computer readable medium of claim 18, wherein the modeled value comprises at least one selected from a group consisting of a stock tank of oil initially in place, a tank of oil initially in place, a reservoir pore volume, a fracture volume, a production rate at a particular time, a pressure at a specified time and matching a pre-specified production plateau period, a time when water breakthrough occurs, and a time when the field reaches a pre-defined low economic viability threshold.

19. The non-transitory computer readable medium of claim 18, wherein the constraint optimization algorithm comprises a Monte-Carlo accept/reject method.
